(19) United States
(12) Patent Application Publication
(10) Pub. No.: US 2025/0286196 A1
(43) Pub. Date: Sep. 11, 2025

(54) MOUNTING ASSEMBLY FOR BATTERY PACKS

(71) Applicant: Caterpillar Inc., Peoria, IL (US)

(72) Inventors: Krishna Prasath Ramabadhran, Krishnagiri (IN); Brian Richard Bell, West Lafayette, IN (US)

(73) Assignee: Caterpillar Inc., Peoria, IL (US)

(21) Appl. No.: 18/596,991

(22) Filed: Mar. 6, 2024

(51) Int. Cl. H01M 50/244

(52) U.S. Cl. CPC H01M 50/244

(57) ABSTRACT

A mounting assembly, for mounting battery pack(s) to a machine, includes a main frame coupled to a structure of the machine, and auxiliary frame(s) coupled to the main frame. The main frame includes first engagement surfaces facilitating at least one of a transportation or a mounting of the main frame on the structure. The main frame defines first mating features and second mating features. Each auxiliary frame includes: mounting features to mount the battery pack(s) on the auxiliary frame; second engagement surfaces facilitating at least one of a transportation or a mounting of the auxiliary frame on the main frame; and coupling features to be engaged with the first mating features when a number of the auxiliary frames to be coupled to the main frame is odd, and with the second mating features when a number of the auxiliary frames to be coupled to the main frame is even.

### TECHNICAL FIELD

The present disclosure relates to energy storage devices, such as battery packs. More specifically, the present disclosure relates to a mounting assembly for mounting battery packs, of different sizes and configurations, onto machines with different power requirements.

### BACKGROUND

Battery packs of different sizes and configurations, for example, a single-string pack configuration, a double-string pack configuration, and so on, are widely used to meet a spectrum of power requirements of a variety of commercial, industrial, or household applications. In an example, a single-string battery pack of 60 kilowatt-hours capacity may be used to power operations of a small-size work machine (e.g., an excavator), whereas a four-string battery pack of 240 kilowatt-hours capacity may be used in a containerized power module to supply electrical power to a power grid. Such varying configurations of battery packs require that each battery pack use a corresponding (and mostly customized) mounting assembly and/or a mechanisms, therefore making one mounting assembly and/or a mechanism different from the other, thus increasing overall cost and inventory.

Chinese patent no. 216,507,983 discloses a battery position expanding mechanism and battery replacing equipment. The battery position expanding mechanism includes a base assembly, a telescopic frame assembly and a supporting frame assembly. The base frame assembly includes at least two base frames sequentially connected, a connecting structure used for connecting and fixing arranged on the base frame assembly. Each base frame is provided with a first battery positioning structure. Each telescopic frame assembly is connected to the corresponding base frame in a sliding mode. Each supporting frame assembly is connected to the corresponding telescopic frame assembly in a sliding manner, and a second battery positioning structure is arranged on each support frame assembly. A first telescopic mechanism is arranged between the telescopic frame assembly and the corresponding base frame, a second telescopic mechanism is arranged between the supporting frame assembly and the telescopic frame assembly. The battery position expanding mechanism can be installed on a chassis of battery replacing equipment, two or more battery positions are expanded, and the battery replacing effect is improved. Once a plurality of battery positions are expanded, all battery boxes on the power transmission vehicle can be stored on the battery replacement equipment at one time.

### SUMMARY OF THE INVENTION

In one aspect, the disclosure relates to a mounting assembly for mounting one or more battery packs to a machine. The mounting assembly includes a main frame and one or more auxiliary frames. The main frame is configured to be coupled to a structure of the machine. The main frame includes first engagement surfaces to engage with an implement to facilitate at least one of a transportation or a mounting of the main frame on the structure. The main frame defines first mating features and second mating features. The one or more auxiliary frames are configured to be coupled to the main frame. Each auxiliary frame includes mounting features, second engagement surfaces, and coupling features. The mounting features is configured to fixedly mount the one or more battery packs on the auxiliary frame. The second engagement surfaces is configured to engage with an equipment to facilitate at least one of a transportation or a mounting of the auxiliary frame on the main frame. The coupling features are configured to be engaged: with the first mating features when a number of the one or more auxiliary frames to be coupled to the main frame is odd; and with the second mating features when a number of the one or more auxiliary frames to be coupled to the main frame is even.

In yet another aspect, the disclosure relates to a method for mounting one or more battery packs to a machine. The method includes coupling a main frame to a structure of the machine. The main frame includes first engagement surfaces to engage with an implement to facilitate at least one of a transportation or a mounting of the main frame on the structure. The main frame defines first mating features and second mating features. Further, the method includes coupling one or more auxiliary frames to the main frame. Each auxiliary frame includes mounting features, second engagement surfaces, and coupling features. The mounting features is configured to fixedly mount the one or more battery packs on the auxiliary frame. The second engagement surfaces is configured to engage with an equipment to facilitate at least one of a transportation or a mounting of the auxiliary frame on the main frame. The coupling features are configured to be engaged: with the first mating features when a number of the one or more auxiliary frames to be coupled to the main frame is odd; and with the second mating features when a number of the one or more auxiliary frames to be coupled to the main frame is even.

### BRIEF DESCRIPTION OF THE DRAWINGS

FIG. 1 illustrates an exemplary machine accommodating a mounting assembly and a battery pack mounted on the mounting assembly, in accordance with an embodiment of the present disclosure;

FIG. 2 illustrates a main frame of the mounting assembly, in accordance with an embodiment of the present disclosure;

FIG. 3 is a bottom cross-sectional view of the main frame, taken along a plane 3-3 parallel to a plane defined by axes A1-A2 of the main frame, in accordance with an embodiment of the present disclosure;

FIG. 4 illustrates an auxiliary frame of the mounting assembly, in accordance with an embodiment of the present disclosure;

FIG. 5 illustrates an assembly of the battery pack and the auxiliary frame, in accordance with an embodiment of the present disclosure;

FIGS. 6 and 7 illustrate an assembly of the auxiliary frame (along with the battery pack mounted thereon) and the main frame, in accordance with an embodiment of the present disclosure; and

FIGS. 8 and 9 illustrate an assembly of two auxiliary frames (along with their corresponding battery packs) and the main frame, in accordance with an embodiment of the present disclosure; and

FIG. 10 illustrate an assembly of the mounting assembly (with the battery pack mounted thereon) and a structure of the machine, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

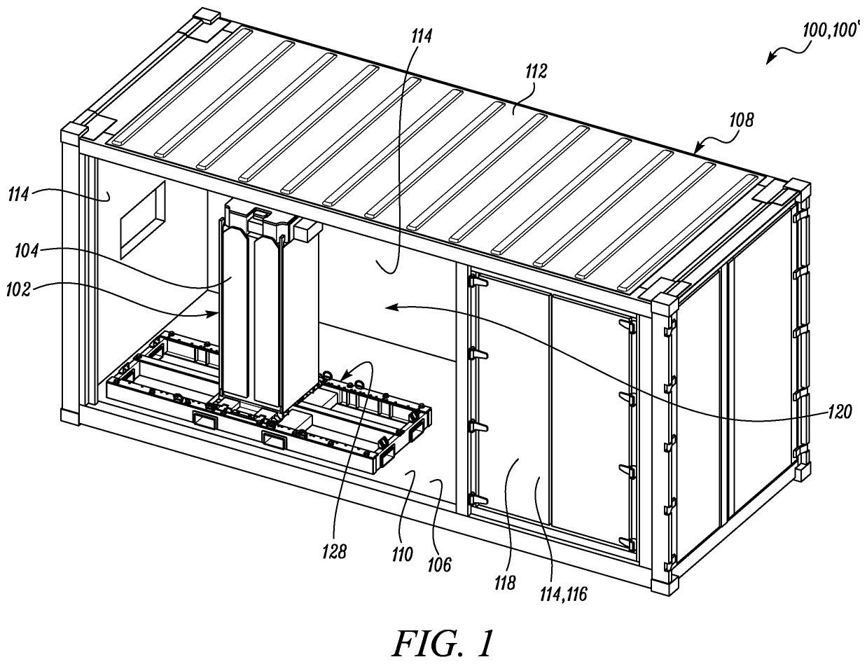

Referring to FIG. 1, an exemplary machine 100 is shown. The machine 100 may be used in various industries and application areas such as construction, forestry, agriculture, mining, excavation etc. In an example, as shown in FIG. 1, the machine 100 is embodied as a containerized power module 100′. Alternatively, the machine 100 may be a mobile machine, for example, an earth-moving machine configured to perform earth altering functions, including displacing, spreading, distributing, leveling, and grading materials. Examples of such mobile machines include, but are not limited to, excavators, backhoe loaders, dozers, pavers, motor graders, loaders, trenchers, scrapers, crushers, draglines, or any type of machine that includes an implement for moving material.

Although references to the containerized power module 100′ are used, aspects of the present disclosure may also be applicable to other machines, such as excavators, backhoe loaders, dozers, pavers, motor graders, loaders, trenchers, scrapers, crushers, draglines, or any other machines known to those skilled in the art, and references to the containerized power module 100′ in the present disclosure is to be viewed as purely exemplary.

The machine 100 (i.e., the containerized power module 100′) may be used to store and/or supply electrical energy, for example, to an electrical grid, or directly to electrical loads. For that, the machine 100 is provided with battery pack(s), such as a battery pack 102. In an example, the battery pack 102 includes a housing 104 and multiple battery modules (not shown) (each battery module formed of one or more battery cells) arranged in a stacked relationship within the housing 104. As shown in FIG. 1, the battery pack 102 is formed of two columns of the battery modules that are electrically coupled to one another to provide a desired electrical energy output and voltage output. It may be contemplated that, in other embodiments, the battery pack 102 may include a higher or lower number of battery modules, each including a suitable number of battery cells, depending on energy storage and supply capacity of the containerized power module 100.

The machine 100 defines a structure 106 for mounting battery packs 102. In an example, as shown in FIG. 1, the machine 100 (e.g., the containerized power module 100′) includes an enclosure 108 that may define a base floor 110, a ceiling 112, and sidewalls 114. The sidewalls 114 may extend between the base floor 110 and the ceiling 112 to connect the base floor 110 with the ceiling 112. At least one sidewall 114, such as a sidewall 116, may include doors, such as a door 118, that may provide access to an interior 120 of the enclosure 108, for example, for mounting the battery pack 102 (or assemblies associated with the machine 100). The base floor 110 may define or be one and the same as the structure 106.

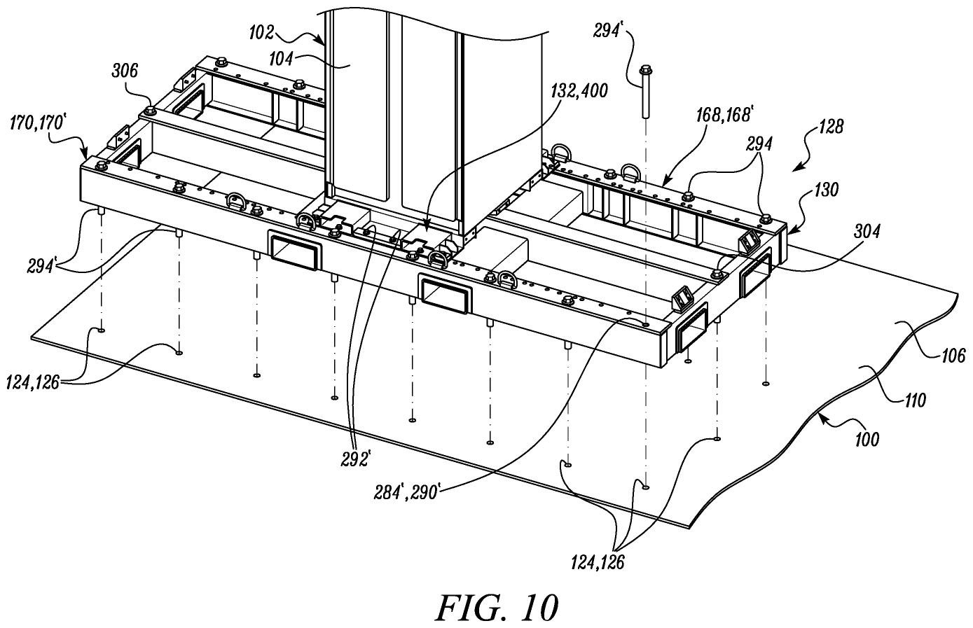

The structure 106 defines at least one mounting arrangement (e.g., mounting arrangement 124), as shown in FIG. 10. The mounting arrangement 124 may include a mounting hole 126. In some cases, the mounting hole 126 may include a threaded hole. The mounting arrangement 124 may facilitate fixedly mounting one or more battery packs (e.g., the battery pack 102) to the structure 106. In the present embodiment, in total eighteen mounting arrangements, such as the mounting arrangement 124, are defined at the structure 106 of the machine 100. The remaining mounting arrangements may be similar to the mounting arrangement 124 in construction and configuration, and hence will not be discussed. Further, higher, or lesser number of the mounting arrangements, such as the mounting arrangement 124, may be provided at various locations on the structure 106 of the machine 100.

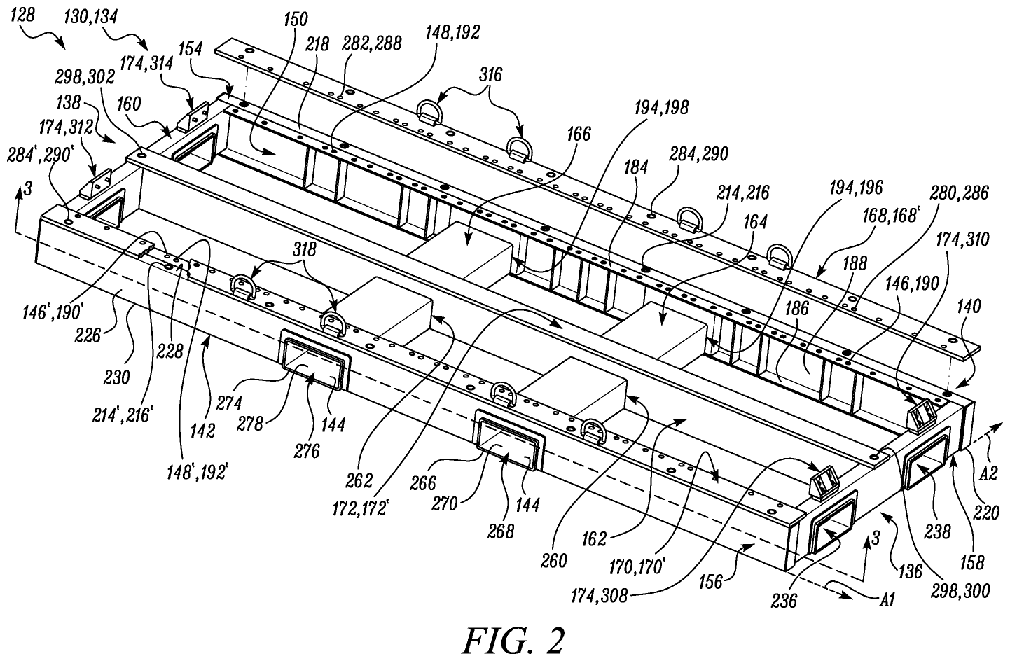

A mounting assembly 128 for mounting the battery pack(s), such as the battery pack 102, on the structure 106 of the machine 100 is now discussed. The mounting assembly 128 includes a main frame 130 and one or more auxiliary frames, such as an auxiliary frame 132. Each of the main frame 130 and the auxiliary frame 132 is discussed with reference to FIGS. 2-4.

The main frame 130 is an elongated main frame 134. The elongated main frame 134 may define a first longitudinal end 136, a second longitudinal end 138, a first lateral end 140, and a second lateral end 142. Each of the first longitudinal end 136 and the second longitudinal end 138 may be spaced from one another in a direction along a longitudinal axis ‘A1’ of the main frame 130, and each of the first lateral end 140 and the second lateral end 142 may be spaced from one another in a direction along a lateral axis ‘A2’ of the main frame 130. Further, the main frame 130 (or the elongated main frame 134) defines a length ‘L1’ that may extend between the first longitudinal end 136 and the second longitudinal end 138 along the longitudinal axis ‘A1’.

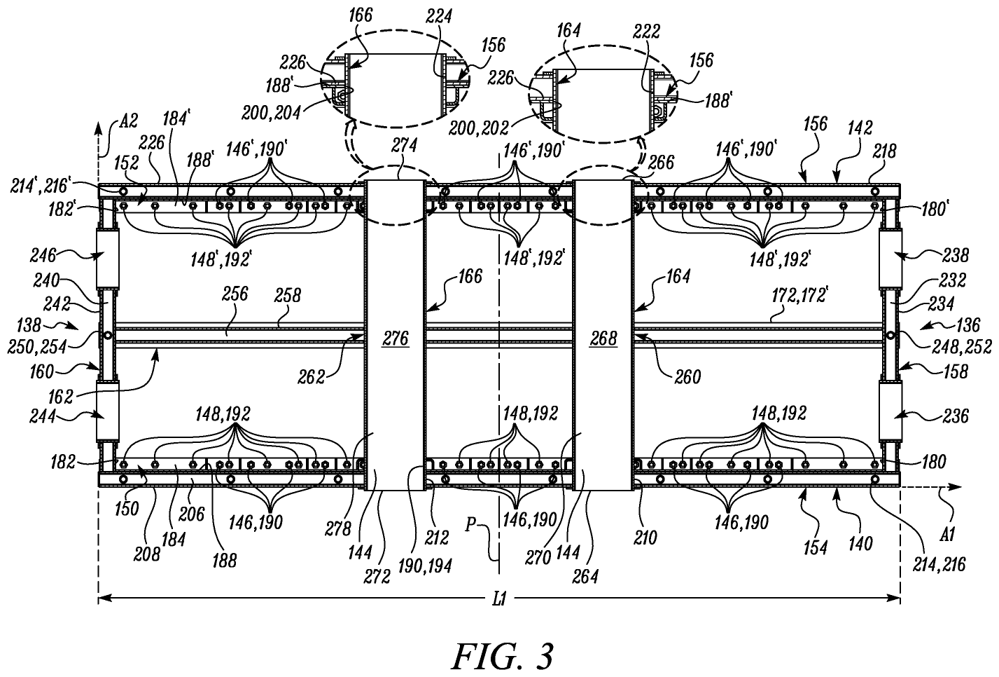

The main frame 130 includes first engagement surfaces 144, first mating features 146, 146′, and second mating features 148, 148. Further, the main frame 130 may include a first rail 150, a second rail 152 (shown in FIG. 3), a first longitudinal beam 154, a second longitudinal beam 156, a first lateral beam 158, and a second lateral beam 160. Furthermore, the main frame 130 may include a reinforcement beam 162. In addition, the main frame 130 may include a first link 164, a second link 166, a first reinforcement plate 168, a second reinforcement plate 170, a third reinforcement plate 172, mounting blocks 174, and tiedown rings 176.

Each of the first rail 150 and the second rail 152 may extend along the length ‘L1’ and between the first longitudinal end 136 and the second longitudinal end 138 of the main frame 130. The first rail 150 and the second rail 152 may be spaced from one another in a direction along the lateral axis ‘A2’. As shown in FIG. 2, the first rail 150 is disposed towards the first lateral end 140, and the second rail 152 is disposed towards the second lateral end 142. For explanatory purposes, the first rail 150 will be explained in detail with reference to FIGS. 2 and 3. However, it should be noted that the description provided below for the first rail 150 is equally applicable to the second rail 152, without any limitations.

The first rail 150 may define a first end 180 (towards the first longitudinal end 136) and a second end 182 (towards the second longitudinal end 138). The first rail 150 may have an open cross-section shape, such as a C-shape, I-shape, or angle. In an example, as shown in FIG. 2, the first rail 150 is a C-shaped rail that includes a first end plate 184 (hereinafter referred to as ‘end plate 184’), a second end plate 186, and a third plate 188. The end plate 184 and the second end plate 186 may extend parallel to a plane defined by the longitudinal axis ‘A1’ and the lateral axis ‘A2’. The third plate 188 may extend from the end plate 184 to the second end plate 186 to connect the end plate 184 with the second end plate 186.

Further, the first rail 150 defines the first mating features 146 and the second mating features 148 of the main frame 130. In an example, as shown in FIG. 3, the first mating features 146 and the second mating features 148 are defined at the end plate 184 of the first rail 150. The first mating features 146 are arranged sequentially on the end plate 184 along the length ‘L1’ of the main frame 130. The first mating features 146 are configured to facilitate coupling an odd number of auxiliary frames 132 to the main frame 130. In an example, as shown in FIGS. 2 and 3, the first mating features 146 may include a set of first through-holes 190. Similarly, the second mating features 148 are arranged sequentially on the end plate 184 along the length ‘L1’ of the main frame 130. The second mating features 148 are configured to facilitate coupling an even number of auxiliary frames 132 to the main frame 130. In an example, as shown in FIGS. 2 and 3, the second mating features 148 may include a set of second through-holes 192.

Furthermore, the first rail 150 may define a plurality of first channels 194. In an example, as shown in FIG. 2, the first rail 150 defines two first channels 196, 198. The first channels 196, 198 may extend across the third plate 188 in a direction along the lateral axis ‘A2’. The first channel 196 may be defined at a first distance from the first channel 198. Each of the first channels 196, 198 may include a rectangular cross-sectional shape. In other embodiments, the first channels 196, 198 may include any suitable cross-sectional shape known in the art.

As stated above, the second rail 152 may have a construction and configuration similar to that of the first rail 150, except that the first mating features 146 and the second mating features 148 are omitted. Instead, the second rail 152 defines the first mating features 146′ and the second mating features 148 of the main frame 130. In an example, as shown in FIG. 3, the first mating features 146′ and the second mating features 148′ are defined at an end plate 184 (shown in FIG. 3) of the second rail 152. The first mating features 146′ are arranged sequentially on the end plate 184′ along the length ‘L1’ of the main frame 130. The first mating features 146′ are configured to facilitate coupling an odd number of auxiliary frames 132 to the main frame 130. In an example, as shown in FIG. 3, the first mating features 146′ may include a set of first through-holes 190. Similarly, the second mating features 148′ are arranged sequentially on the end plate 184′ along the length ‘L1’ of the main frame 130. The second mating features 148′ are configured to facilitate coupling an even number of auxiliary frames 132 to the main frame 130. In an example, as shown in FIG. 3, the second mating features 148′ may include a set of second through-holes 192.

Further, instead of the first channels 194 (i.e., the first channels 196, 198), the second rail 152 defines a plurality of second channels 200. In an example, as shown in FIG. 3, the second rail 152 defines two second channels 202, 204. The second channels 202, 204 may extend across a third plate 188 (shown in FIG. 3) of the second rail 152 in a direction along the lateral axis ‘A2’. The second channel 202 may be defined at a second distance from the second channel 204. The second distance (between the second channels 202, 204) may be equal to the first distance (between the first channels 196, 198). Each of the second channels 202, 204 may include a rectangular cross-sectional shape. In other embodiments, the second channels 202, 204 may include any suitable cross-sectional shape known in the art.

The first longitudinal beam 154 may have a closed cross-section shape, such as a rectangular cross-section shape, a square cross-section shape, an oval cross-section shape, a hexagonal cross-section shape, or any irregular cross-section shape. In an example, as shown in FIGS. 2 and 3, the first longitudinal beam 154 has a rectangular cross-section shape. The first longitudinal beam 154 may include an interior cavity 206 and a wall 208 surrounding the interior cavity 206 (as shown in FIG. 3). Alternatively, the first longitudinal beam 154 may have an open cross-section shape, such as a C-channel, I-beam, or angle.

Further, the first longitudinal beam 154 may define first apertures 210, 212. The first apertures 210, 212 may extend across the wall 208 of the first longitudinal beam 154 in a direction along the lateral axis ‘A2’. The first aperture 210 may be defined at a third distance from the first aperture 212. The third distance (between the first apertures 210, 212) may be equal to the first distance (between the first channels 196, 198). Each of the first apertures 210, 212 may include a rectangular cross-sectional shape. In other embodiments, the first apertures 210, 212 may include any suitable cross-sectional shape known in the art.

The first longitudinal beam 154 includes first connecting features 214. The first connecting features 214 may facilitate coupling the main frame 130 (e.g., the first lateral end 140) to the structure 106 (of the machine 100). In an example, as shown in FIGS. 2 and 3, the first connecting features 214 includes a set of first through-bores 216 arranged sequentially along a length of the first longitudinal beam 154. Each of the first through-bores 216 may extend from a top wall portion 218 to a bottom wall portion 220 of the wall 208 (of the first longitudinal beam 154) in a direction transverse to the longitudinal axis ‘A1’ and the lateral axis ‘A2’. As shown in FIG. 2, the top wall portion 218 and the end plate 184 (of the first rail 150) lie in a common plane parallel to a plane defined by the longitudinal axis ‘A1’ and the lateral axis ‘A2’.

The first longitudinal beam 154 may be disposed towards the first lateral end 140 of the main frame 130. The first longitudinal beam 154 may be coupled to the first rail 150. In an example, as shown in FIGS. 2 and 3, a portion of the wall 208 (of the first longitudinal beam 154) may be coupled to the third plate 188 of the first rail 150, by a welded connection (not shown) therebetween, such that the first apertures 210, 212 (of the first longitudinal beam 154) may correspondingly align with the first channels 196, 198 (of the first rail 150).

The construction and configuration of the second longitudinal beam 156 may be similar to that of the first longitudinal beam 154, except that the first apertures 210, 212 are omitted. Instead, the second longitudinal beam 156 may define second apertures 222, 224. The second apertures 222, 224 may extend across the wall 226 of the second longitudinal beam 156 in a direction along the lateral axis ‘A2’. The second aperture 222 may be defined at a fourth distance from the second aperture 224. The fourth distance (between the second apertures 222, 224) may be equal to the second distance (between the second channels 202, 204). Each of the second apertures 222, 224 may include a rectangular cross-sectional shape. In other embodiments, the second apertures 222, 224 may include any suitable cross-sectional shape known in the art.

Further, the second longitudinal beam 156 includes first connecting features 214′ (shown in FIG. 3) (similar to the first connecting features 214). The first connecting features 214′ may facilitate coupling the main frame 130 (e.g., the second lateral end 142) to the structure 106 (of the machine 100). In an example, as shown in FIG. 3, the first connecting features 214′ includes a set of first through-bores 216′ arranged sequentially along a length of the second longitudinal beam 156. Each of the first through-bores 216′ may extend from a top wall portion 228 to a bottom wall portion 230 of the wall 226 (of the second longitudinal beam 156) in a direction transverse to the longitudinal axis ‘A1’ and the lateral axis ‘A2’. The top wall portion 228 and the end plate 184 (of the second rail 152) lie in a common plane parallel to a plane defined by the longitudinal axis ‘A1’ and the lateral axis ‘A2’.

The second longitudinal beam 156 may be disposed towards the second lateral end 142 of the main frame 130. The second longitudinal beam 156 may be coupled to the second rail 152. In an example, as shown in FIG. 3, a portion of the wall 226 of the second longitudinal beam 156 may be coupled to the third plate 188′ of the second rail 152, by a welded connection (not shown) therebetween, such that the second apertures 222, 224 may correspondingly align with the second channels 202, 204 (of the second rail 152).

The first lateral beam 158 may extend between the first rail 150 and the second rail 152 to couple the first ends 180, 180 of the first rail 150 and the second rail 152 respectively, for example, via welded connections. The first lateral beam 158 may have a closed cross-section shape, such as a rectangular cross-section shape, a square cross-section shape, an oval cross-section shape, a hexagonal cross-section shape, or any irregular cross-section shape. In an example, as shown in FIGS. 2 and 3, the first lateral beam 158 has a rectangular cross-section shape. The first lateral beam 158 may include an interior cavity 232 and a wall 234 surrounding the interior cavity 232. In other embodiments, the first lateral beam 158 may have an open cross-section shape, such as a C-channel, I-beam, or angle.

Further, the first lateral beam 158 may define openings, namely-first openings 236, 238. The first openings 236, 238 may extend across the wall 234 of the first lateral beam 158 in a direction along the longitudinal axis ‘A1’. The first opening 236 may be defined at a fifth distance from the first opening 238. Each of the first openings 236, 238 may be configured to receive a work tool (e.g., a forklift tine, not shown) to facilitate a transportation of the main frame 130 from one location to another location (e.g., in a manufacturing facility), or to facilitate mounting of the main frame 130, for example, on the structure 106 of the machine 100.

The second lateral beam 160 may extend between the first rail 150 and the second rail 152 to couple the second ends 182, 182 of the first rail 150 and the second rail 152 respectively, for example, via welded connections. The second lateral beam 160 may have a closed cross-section shape, such as a rectangular cross-section shape, a square cross-section shape, an oval cross-section shape, a hexagonal cross-section shape, or any irregular cross-section shape. In an example, as shown in FIGS. 2 and 3, the second lateral beam 160 has a rectangular cross-section shape. The second lateral beam 160 may include an interior cavity 240 and a walls 242 surrounding the interior cavity 240. In other embodiments, the second lateral beam 160 may have an open cross-section shape, such as a C-channel, I-beam, or angle.

Further, the second lateral beam 160 may define openings, namely-second openings 244, 246. The second openings 244, 246 may extend across the wall 242 of the second lateral beam 160, for example, in a direction along the longitudinal axis ‘A1’. The second opening 244 may be defined at a sixth distance from the second opening 246. The sixth distance may be equal to the fifth distance (between the first openings 236, 238). Each of the second openings 244, 246 may be configured to receive a work tool (e.g., a forklift tine, not shown) to facilitate transportation of the main frame 130 from one location to another location (e.g., in a manufacturing facility), or to facilitate mounting of the main frame 130, for example, on the structure 106 of the machine 100.

Continuing with FIG. 3, the first lateral beam 158 and the second lateral beam 160 includes second connecting features 248, 250, respectively. The second connecting features 248, 250 may facilitate coupling the first longitudinal end 136 and the second longitudinal end 138 respectively (of the main frame 130) to the structure 106 of the machine 100. In an example, the second connecting features 248 includes a through-bore 252 that extend through the wall 234 (of the first lateral beam 158) in a direction transverse to the longitudinal axis ‘A1’ and the lateral axis ‘A2’, and the second connecting features 250 includes a through-bore 254 that extend through the wall 242 (of the second lateral beam 160) in a direction transverse to the longitudinal axis ‘A1’ and the lateral axis ‘A2’.

The reinforcement beam 162 may extend between the first lateral beam 158 and the second lateral beam 160 in a direction along the longitudinal axis ‘A1’ to couple the first lateral beam 158 with the second lateral beam 160. The reinforcement beam 162 may include an interior cavity 256 and a wall 258 surrounding the interior cavity 256 (as shown in FIG. 3). The reinforcement beam 162 may define third apertures 260, 262. The third apertures 260, 262 may extend across the wall 258 of the reinforcement beam 162, for example, in a direction along the lateral axis ‘A2’. The third aperture 260 may be defined at a seventh distance from the third aperture 262. The seventh distance (between the third apertures 260, 262) may be equal to the first distance (between the first channels 194, 196).

The first link 164 may include a tubular element or a beam. The first link 164 may include a cross-sectional shape complementary to cross-sectional shapes of the first channel 196, the second channel 202, the first aperture 210, the second aperture 222, and the third aperture 260. In an example, as shown in FIGS. 2 and 3, the first link 164 has a rectangular cross-sectional shape. The first link 164 defines a first end 264 and a second end 266. In addition, the first link 164 includes a first pocket 268. The first pocket 268 may extend from the first end 264 to the second end 266. The first pocket 268 defines a first engagement surface 270 (of the first engagement surfaces 144) of the main frame 130. The first engagement surface 270 is configured to engage with an implement (e.g., a forklift tine) to facilitate transportation of the main frame 130 from one location to another location (e.g., in a manufacturing facility), or to facilitate mounting of the main frame 130, for example, on the structure 106 of the machine 100.

The first link 164 is fixedly coupled (e.g., welded) to the first rail 150 at the first end 264 and is fixedly coupled (e.g., welded) to the second rail 152 at the second end 266, thereby coupling the first rail 150 with the second rail 152. In an exemplary assembly, as shown in FIG. 3, the first link 164 passes through and is received within the first channel 196, the second channel 202, the first aperture 210, the second aperture 222, and the third aperture 260. Once assembled, the first end 264 may extend outwardly from the first longitudinal beam 154 towards the first lateral end 140 (of the main frame 130), and the second end 266 may extend outwardly from the second longitudinal beam 156 towards the second lateral end 142 (of the main frame 130).

The second link 166 may include a tubular element or a beam. The second link 166 may include a cross-sectional shape complementary to cross-sectional shapes of the first channel 198, the second channel 204, the first aperture 212, the second aperture 224, and the third aperture 262. In an example, as shown in FIGS. 2 and 3, the second link 166 has a rectangular cross-sectional shape. The second link 166 defines a first end 272 and a second end 274. In addition, the second link 166 includes a second pocket 276. The second pocket 276 may extend from the first end 272 to the second end 274. The second pocket 276 defines a first engagement surface 278 of the first engagement surfaces 144 of the main frame 130. The first engagement surface 278 is configured to engage with an implement (e.g., a forklift tine) to facilitate transportation of the main frame 130 from one location to another location (e.g., in a manufacturing facility), or to facilitate mounting of the main frame 130, for example, on the structure 106 of the machine 100.

The second link 166 is fixedly coupled (e.g., welded) to the first rail 150 at the first end 272 and is fixedly coupled (e.g., welded) to the second rail 152 at the second end 274, thereby coupling the first rail 150 with the second rail 152. In an exemplary assembly, as shown in FIG. 3, the second link 166 passes through and is received within the first channel 198, the second channel 204, the first aperture 212, the second aperture 224, and the third aperture 262. Once assembled, the first end 272 may extend outwardly from the first longitudinal beam 154 towards the first lateral end 140 (of the main frame 130), and the second end 274 may extend outwardly from the second longitudinal beam 156 towards the second lateral end 142 (of the main frame 130).

The first reinforcement plate 168 may be a flat elongated plate 168 having a shape in conformance with the shape of the top wall portion 218 (of the first longitudinal beam 154) and the end plate 184 (of the first rail 150). The first reinforcement plate 168 may define third mating features 280, fourth mating features 282, and third connecting features 284. The third mating features 280 may include through-holes 286 complementary to the first through-holes 190 (i.e., the first mating features 146). The fourth mating features 282 may include through-holes 288 complementary to the second through-holes 192 (i.e., the second mating features 148). The third connecting features 284 may include through-holes 290 complementary to the first through-bores 216 (i.e., the first connecting features 214).

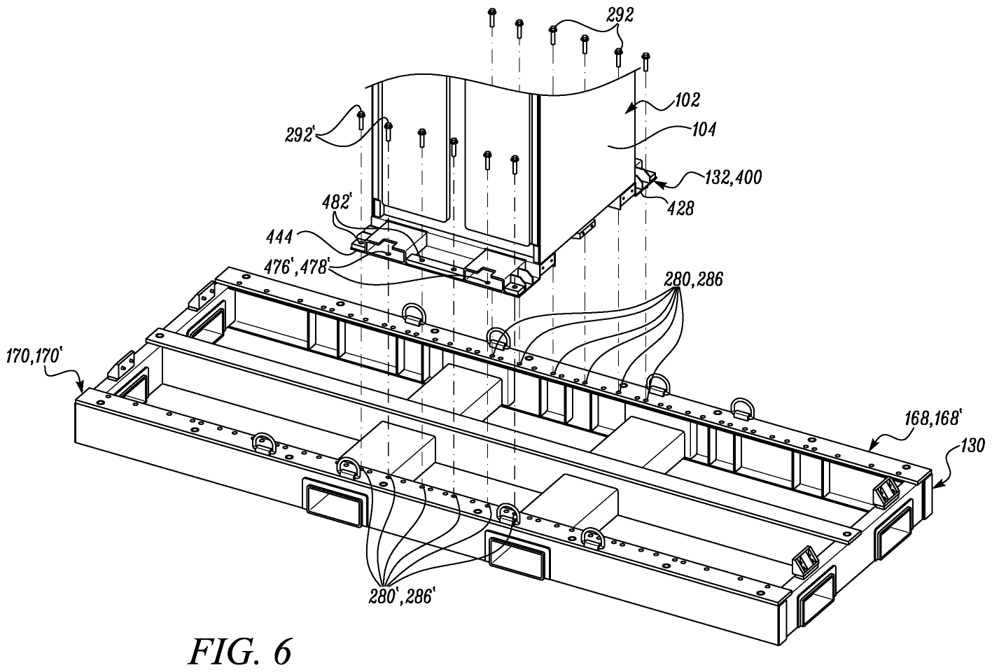

The first reinforcement plate 168 is connected to the first longitudinal beam 154 and the first rail 150. In an example, as shown in FIG. 2, the first reinforcement plate 168 is abutted against the top wall portion 218 (of the first longitudinal beam 154) and the end plate 184 (of the first rail 150), and is coupled to the top wall portion 218 and the end plate 184, via welded connections. In this configuration, the third mating features 280 and the fourth mating features 282 are respectively aligned with their corresponding first mating features 146 and the second mating features 148 of the first rail 150, and the third connecting features 284 are aligned with their corresponding first connecting features 214 of the first longitudinal beam 154. Once connected to the first longitudinal beam 154 and the first rail 150, the first reinforcement plate 168 supports the first longitudinal beam 154 and the first rail 150 to withstand loads, such as, fastening loads applied to the first through-holes 190, the second through-holes 192, and the first through-bores 216, by their corresponding fasteners 292 and 294 (shown in FIGS. 6, 8, and 10).

The construction and configuration of the second reinforcement plate 170 may be similar to that of the first reinforcement plate 168, except that the third mating features 280, the fourth mating features 282, and the third connecting features 284 are omitted. Instead, the second reinforcement plate 170 may define third mating features 280′, fourth mating features 282, and third connecting features 284. The third mating features 280′ may include through-holes 286 complementary to the first through-holes 190′ (i.e., the first mating features 146′). The fourth mating features 282′ may include through-holes 288′ complementary to the second through-holes 192 (i.e., the second mating features 148). The third connecting features 284′ may include through-holes 290′ complementary to the first through-bores 216′ (i.e., the first connecting features 214′).

The second reinforcement plate 170 is connected to the second longitudinal beam 156 and the second rail 152, via welded connections, such that the third mating features 280′ and the fourth mating features 282′ are aligned with their corresponding first mating features 146′ and the second mating features 148 (of the second rail 152) respectively, and the third connecting features 284′ are aligned with their corresponding first connecting features 214′ of the second longitudinal beam 156. Once connected to the second longitudinal beam 156 and the second rail 152, the second reinforcement plate 170 supports the second longitudinal beam 156 and the second rail 152 to withstand loads, such as, fastening loads applied to the first through-holes 190′, the second through-holes 192, and the first through-bores 216′, by their corresponding fasteners 292′ and 294 (shown in FIGS. 6, 8, and 10).

The third reinforcement plate 172 may be a flat elongated plate 172. The third reinforcement plate 172 may define fourth connecting features 298. The fourth connecting features 298 may include through-holes 300, 302 complementary to the through-bores 252, 254, respectively (i.e., the second connecting features 248, 250). The third reinforcement plate 172 is connected to the first lateral beam 158, the second lateral beam 160, and the reinforcement beam 162, for example, via welded connections, such that the through-holes 300, 302 are respectively aligned with their corresponding through-bores 252, 254. Once connected, the third reinforcement plate 172 supports the first lateral beam 158 and the second lateral beam 160 to withstand loads, such as, fastening loads applied to the through-bores 252, 254 (or the second connecting features 248, 250), by their respective fasteners 304, 306 (shown in FIG. 10).

The mounting blocks 174 may be fixedly mounted on the first lateral beam 158 and the second lateral beam 160. In an example, as shown in FIG. 2, two mounting blocks 308, 310 (of the mounting blocks 174) are connected on the first lateral beam 158, for example, via welded connections. Similarly, two mounting blocks 312, 314 (of the mounting blocks 174) are mounted on the second lateral beam 160, for example, via welded connections. The mounting blocks 308, 310, 312, 314 may restrict movement of the auxiliary frames 132 (mounted to the main frame 130) and the battery packs 102 (each fixedly mounted to the auxiliary frame 132) with respect to the main frame 130, for example, in a direction along the longitudinal axis ‘A1’ under loading conditions.

The tiedown rings 176 may be fixedly mounted on the first reinforcement plate 168 and the second reinforcement plate 170. In an example, as shown in FIG. 2, four tiedown rings 316 (of the tiedown rings 176) are connected to the first reinforcement plate 168, for example, via welded connections. Similarly, four tiedown rings 318 (of the tiedown rings 176) are connected to the second reinforcement plate 170, for example, via welded connections. The tiedown rings 316, 318 may be configured to secure the battery pack(s) 102 (fixedly mounted on the auxiliary frame 132 that, in turn, is mounted on the main frame 130) onto the main frame 130, for example, using a rope (not shown) that may extend between the tiedown rings 316, 318 and the battery pack(s) 102. The tiedown rings 316, 318 enable safe and secure transportation of the battery pack(s) 102 along with corresponding auxiliary frame 132 and the main frame 130.

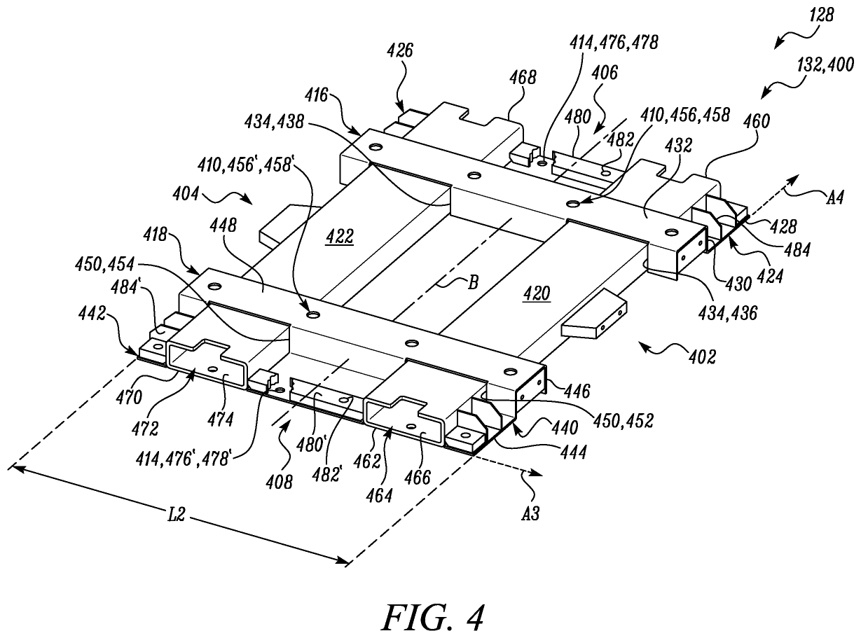

Referring to FIG. 4, an auxiliary frame 400 of the one or more auxiliary frames 132 is discussed. It should be noted that the description provided below for the auxiliary frame 400 is equally applicable to the remaining auxiliary frames 132, without any limitations. The auxiliary frame 400 may define a third longitudinal end 402, a fourth longitudinal end 404, a third lateral end 406, and a fourth lateral end 408. Each of the third longitudinal end 402 and the fourth longitudinal end 404 may be spaced from one another in a direction along a longitudinal axis ‘A3’ of the auxiliary frame 400, and each of the third lateral end 406 and the fourth lateral end 408 may be spaced from one another in a direction along a lateral axis ‘A4’ of the auxiliary frame 400. Further, the auxiliary frame 400 defines a length ‘L2’ that may extend between the third longitudinal end 402 and the fourth longitudinal end 404 along the longitudinal axis ‘A3’.

The auxiliary frame 400 includes mounting features 410, second engagement surfaces 412, and coupling features 414. In addition, the auxiliary frame 400 may include a third rail 416, a fourth rail 418, a third link 420, and a fourth link 422.

Each of the third rail 416 and the fourth rail 418 may extend along the length ‘L2’ and between the third longitudinal end 402 and the fourth longitudinal end 404 of the auxiliary frame 400. The third rail 416 and the fourth rail 418 may be spaced from one another in a direction along the lateral axis ‘A4’. As shown in FIG. 4, the third rail 416 is disposed towards the third lateral end 406, and the fourth rail 418 is disposed towards the fourth lateral end 408.

The third rail 416 may define a first end 424 (towards the third longitudinal end 402) and a second end 426 (towards the fourth longitudinal end 404). The third rail 416 may have an open cross-section shape. In an example, as shown in FIG. 4, the third rail 416 defines a base portion 428 and a ridge 430. The base portion 428 may extend between the first end 424 and the second end 426. In addition, the base portion 428 may extend parallel to a plane defined by the longitudinal axis ‘A3’ and the lateral axis ‘A4’. The ridge 430 may extend outwardly from the base portion 428 in a direction transverse to the longitudinal axis ‘A3’ and the lateral axis ‘A4’ to define a ridge top surface 432 away from the base portion 428. The ridge top surface 432 may extend parallel to a plane defined by the longitudinal axis ‘A3’ and the lateral axis ‘A4’.

Further, the third rail 416 may define a plurality of third channels 434. In an example, as shown in FIG. 4, the third rail 416 defines third channels 436, 438. The third channels 436, 438 may be sequentially defined on the third rail 416 in a direction along the longitudinal axis ‘A4’. The third channels 436, 438 may extend across the base portion 428 and the ridge 430, for example, in a direction along the lateral axis ‘A4’. The third channels 436, 438 may include a rectangular cross-sectional shape. In other embodiments, the third channels 436, 438 may include any suitable cross-sectional shape known in the art.

The fourth rail 418 may define a first end 440 (towards the third longitudinal end 402) and a second end 442 (towards the fourth longitudinal end 404). The fourth rail 418 may have an open cross-section shape. In an example, as shown in FIG. 4, the fourth rail 418 defines a base portion 444 and a ridge 446. The base portion 444 may extend between the first end 440 and the second end 442. In addition, the base portion 444 may extend parallel to a plane defined by the longitudinal axis ‘A3’ and the lateral axis ‘A4’. The ridge 446 may extend outwardly from the base portion 444 in a direction transverse to the longitudinal axis ‘A3’ and the lateral axis ‘A4’ to define a ridge top surface 448 away from the base portion 444. The ridge top surface 448 may extend parallel to a plane defined by the longitudinal axis ‘A3’ and the lateral axis ‘A4’.

Further, the fourth rail 418 may define a plurality of fourth channels 450. In an example, as shown in FIG. 4, the fourth rail 418 defines fourth channels 452, 454. The fourth channels 452, 454 may be sequentially defined on the fourth rail 418 in a direction along the longitudinal axis ‘A4’. The fourth channels 452, 454 may extend across the base portion 444 and the ridge 446, for example, in a direction along the lateral axis ‘A4’. The fourth channels 452, 454 may include a rectangular cross-sectional shape. In other embodiments, the fourth channels 452, 454 may include any suitable cross-sectional shape known in the art.

Mounting features 456, 456′ (of the mounting features 410) are defined on the ridge top surfaces 432, 448, respectively. The mounting features 456 may be arranged sequentially on the ridge top surface 432 (of the third rail 416), and the mounting features 456′ may be arranged sequentially on the ridge top surface 448 (of the fourth rail 418). In an example, as shown in FIG. 4, the mounting features 456, 456′ include mounting through-holes 458, 458, respectively. The mounting features 456, 456′ (or mounting through-holes 458, 458) are configured to facilitate fixedly mounting one battery pack 102 on the auxiliary frame 400. In other embodiments, the mounting features 456, 456′ may facilitate fixedly mounting more than one battery pack 102 on the auxiliary frame 400.

Continuing with FIG. 4, the third link 420 and the fourth link 422 are discussed. The third link 420 may include a tubular element, or a beam. The third link 420 may include a cross-sectional shape complementary to cross-sectional shapes of the third channel 436 and the fourth channel 452. In an example, as shown in FIG. 4, the third link 420 has a rectangular cross-sectional shape. The third link 420 defines a first end 460 and a second end 462. In addition, the third link 420 includes a third pocket 464. The third pocket 464 may extend from the first end 460 to the second end 462. The third pocket 464 defines a second engagement surface 466 of the second engagement surfaces 412 of the auxiliary frame 400. The second engagement surface 466 is configured to engage with an equipment (e.g., a forklift tine) to facilitate transportation of the auxiliary frame 400 from one location to another location (e.g., in a manufacturing facility), or to facilitate mounting of the auxiliary frame 400 on the main frame 130.

The third link 420 is fixedly coupled to the third rail 416 and the fourth rail 418. In an exemplary assembly, as shown in FIG. 4, the third link 420 passes through and is received within the third channel 436 and the fourth channel 452 such that the third link 420 is coupled (e.g., welded) to the third rail 416 at the first end 460 and to the fourth rail 418 at the second end 462, thereby coupling the third rail 416 with the fourth rail 418.

The fourth link 422 may include a tubular element, or a beam. The fourth link 422 may include a cross-sectional shape complementary to cross-sectional shapes of the third channel 438 and the fourth channel 454. In an example, as shown in FIG. 4, the fourth link 422 has a rectangular cross-sectional shape. The fourth link 422 defines a first end 468 and a second end 470. In addition, the fourth link 422 includes a fourth pocket 472. The fourth pocket 472 may extend from the first end 468 to the second end 470. The fourth pocket 472 defines a second engagement surface 474 of the second engagement surfaces 412 of the auxiliary frame 400. The second engagement surface 474 is configured to engage with an equipment (e.g., a forklift tine) to facilitate transportation of the auxiliary frame 400 from one location to another location (e.g., in a manufacturing facility), or to facilitate mounting of the auxiliary frame 400 on the main frame 130.

The fourth link 422 is fixedly coupled to the third rail 416 and the fourth rail 418. In an exemplary assembly, as shown in FIG. 4, the fourth link 422 passes through and is received within the third channel 438 and the fourth channel 454 such that the fourth link 422 is coupled (e.g., welded) to the third rail 416 at the first end 468 and to the fourth rail 418 at the second end 470, thereby coupling the third rail 416 with the fourth rail 418.

The coupling features 414 includes coupling features 476, 476′. The coupling features 476 are defined on the base portion 428, the third link 420 (e.g., towards the first end 460), and the fourth link 422 (e.g., towards the first end 468). The coupling features 476 may be arranged sequentially on the base portion 428, the third link 420, and the fourth link 422 in a direction along the longitudinal axis ‘A3’. In an example, as shown in FIG. 4, the coupling features 476 include a set of third through-holes 478. Similarly, the coupling features 476′ are defined on the base portion 444, the third link 420 (e.g., towards the second end 462), and the fourth link 422 (e.g., towards the second end 470). The coupling features 476′ may be arranged sequentially on the base portion 444, the third link 420, and the fourth link 422 in a direction along the longitudinal axis ‘A3’. In an example, as shown in FIG. 4, the coupling features 476′ include a set of third through-holes 478.

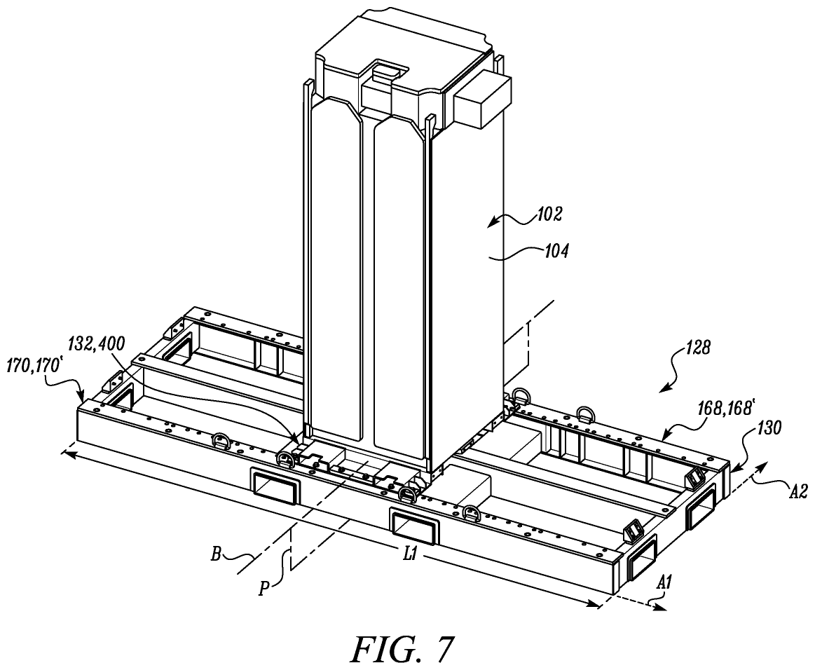

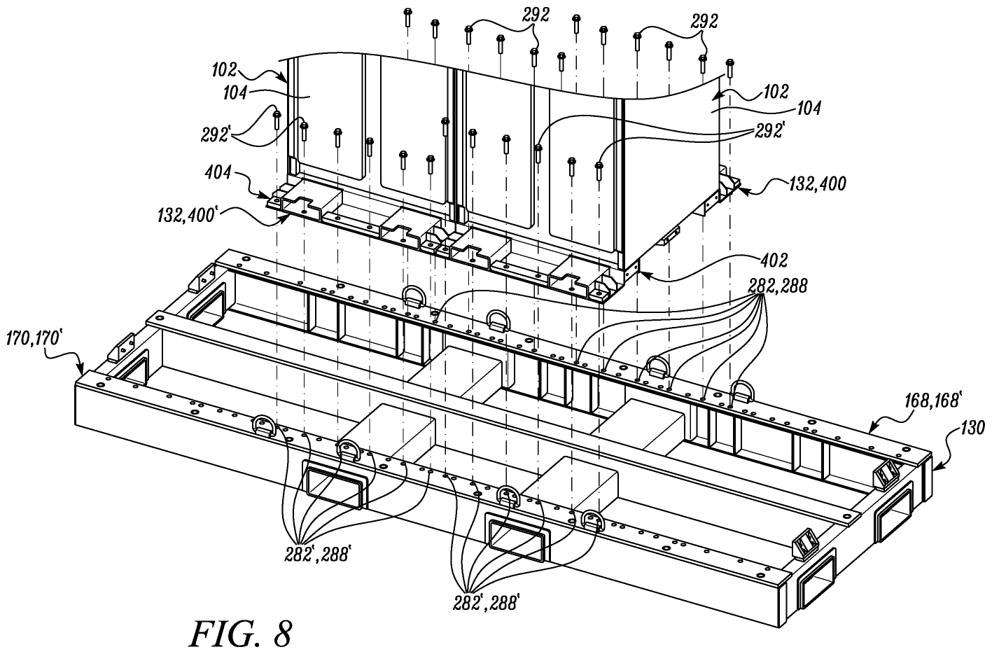

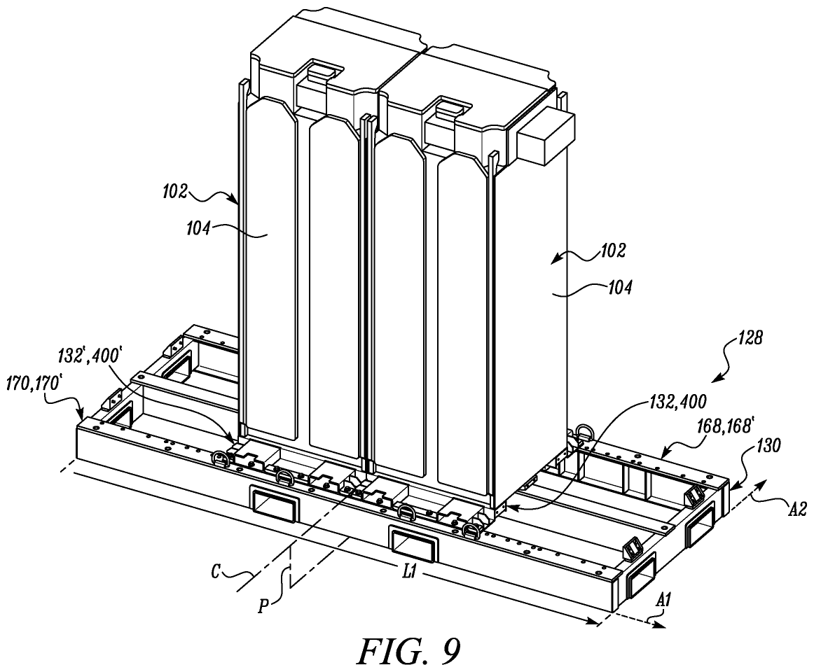

The coupling features 476, 476′ facilitates mounting the auxiliary frame 400 onto the main frame 130. In one instance, the coupling features 476, 476 (i.e., third through-holes 478, 478) are configured to correspondingly engage (e.g., via respective fasteners 292, 292) with the first mating features 146, 146 (i.e., first through-holes 190, 190) of the main frame 130 when a number of the auxiliary frames 132 to be coupled to the main frame 130 is odd, for example, one auxiliary frame 400 (as shown in FIGS. 6 and 7). In another instance, the coupling features 476, 476′ (i.e., third through-holes 478, 478) are configured to correspondingly engage (e.g., via respective fasteners 292, 292′) with the second mating features 148, 148 (i.e., second through-holes 192, 192′) of the main frame 130 when a number of the auxiliary frames 132 to be coupled to the main frame 130 is even, for example, two auxiliary frames 400, 400 (respectively carrying two battery packs 102, 102) (as shown in FIGS. 8 and 9).

Additionally, the auxiliary frame 400 may include a first set of reinforcement plates 480 and a second set of reinforcement plates 480. The reinforcement plates 480 may be fixedly coupled (e.g., welded) to the base portion 428. As shown in FIG. 4, the reinforcement plates 480 define through-holes 482 complementary to the third through-holes 478 (i.e., the coupling features 476). In an exemplary assembly of the reinforcement plates 480 with the base portion 428, the reinforcement plates 480 are placed on the base portion 428 such that the through-holes 482 are aligned with their corresponding third through-holes 478, and are welded to the base portion 428. Once coupled, the reinforcement plates 480 support the auxiliary frame 400 to withstand loads, such as, fastening loads applied to the third through-holes 478 by the fasteners 292.

The reinforcement plates 480′ may be fixedly coupled (e.g., welded) to the base portion 444. As shown in FIG. 4, the reinforcement plates 480′ define through-holes 482 complementary to the third through-holes 478 (i.e., the coupling features 476′). In an exemplary assembly of the reinforcement plates 480′ with the base portion 444, the reinforcement plates 480′ are placed on the base portion 444 such that the through-holes 482′ are aligned with their corresponding third through-holes 478, and are welded to the base portion 444. Once coupled, the reinforcement plates 480′ support the auxiliary frame 400 to withstand loads, such as, fastening loads applied to the third through-holes 478 by the fasteners 292.

In some embodiments, the auxiliary frame 400 may include reinforcement ribs, such as ribs 484, 484′. The ribs 484 may be fixedly coupled to the base portion 428, the third link 420, and the fourth link 422. The ribs 484 may be fixedly coupled to the base portion 444, the third link 420, and the fourth link 422. The ribs 484, 484′ may support the auxiliary frame 400 in retaining its shape under loading.

### INDUSTRIAL APPLICABILITY

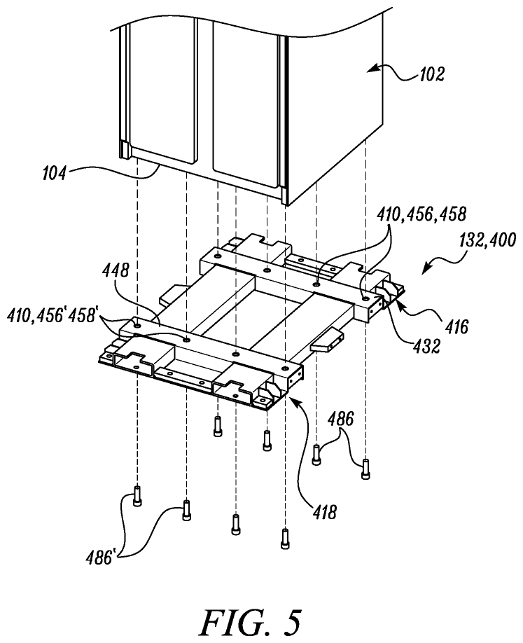

An exemplary method for mounting one or more battery packs, such as the battery pack 102, 102, to the machine 100 is discussed. The method is discussed in conjunction with FIGS. 5-10. Initially, the one or more battery packs 102 are assembled with the one or more auxiliary frames 132. In an exemplary assembly of the battery pack 102 with the auxiliary frame 400 (of the auxiliary frames 132), as shown in FIG. 5, the battery pack 102 is placed on the ridge top surfaces 432, 448 such that the mounting through-holes 458, 458 are aligned with their corresponding fastening holes (not shown) formed on the housing 104 of the battery pack 102. Subsequently, fasteners 486, 486′ are inserted into their respective mounting through-holes 458, 458 and the fastening holes (formed on the housing 104) to fixedly secure the battery pack 102 to the auxiliary frame 400.

Next, the one or more auxiliary frames 132 (along with their respective battery pack(s) 102 mounted thereon) are coupled to the main frame 130. In an exemplary assembly of an odd number of auxiliary frames 132 (e.g., one auxiliary frame 400) with the main frame 130, as shown in FIGS. 6 and 7, the auxiliary frame 400 is transported and mounted on the main frame 130, for example, by using tines of the equipment (e.g., forklift) (not shown) received within their corresponding second engagement surfaces 412 (e.g., second engagement surfaces 466, 474) of the auxiliary frame 400. The auxiliary frame 400 is mounted onto the main frame 130 in a manner such that the base portions 428, 444 (of the auxiliary frame 400) are placed on the first reinforcement plate 168 and the second reinforcement plate 170, respectively, of the main frame 130. In addition, the auxiliary frame 400 is positioned onto the main frame 130 such that the coupling features 476, 476 (i.e., third through-holes 478, 478) (and the through-holes 482, 482) are aligned with their corresponding first mating features 146, 146′ (i.e., first through-holes 190, 190′) (and the through-holes 286, 286′) of the main frame 130. Next, the fasteners 292, 292 are inserted into the corresponding third through-holes 478, 478, the through-holes 482, 482, the first through-holes 190, 190, and the through-holes 286, 286′, and are tightened to fixedly secure the auxiliary frame 400 to the main frame 130.

When the odd number of the auxiliary frames 132, such as the auxiliary frame 400, is mounted on the main frame 130 in the above-discussed configuration, a geometrical center (lying along a dashed line ‘B’ bisecting the length ‘L2’ of the auxiliary frame 400, as shown in FIG. 4) of the auxiliary frame 400 lies on or along a plane ‘P’ symmetrically bisecting the main frame 130 about the length ‘L1’ of the main frame 130, as shown in FIGS. 3 and 7. As a result of this mounting arrangement for odd number of the auxiliary frames 132, a center of gravity defined combinedly by the battery pack 102 and the mounting assembly 128 (i.e., the auxiliary frame 400 and the main frame 130) may be defined on or along the plane ‘P’.

Referring to FIGS. 8 and 9, an exemplary assembly of an even number of auxiliary frames 132 (e.g., two auxiliary frames 400, 400′ with their corresponding battery packs 102) with the main frame 130 is discussed. The auxiliary frames 400, 400 are transported and mounted (simultaneously as shown in FIGS. 6 and 7, or one at a time in a serial manner), for example, by using tines of the equipment in the same manner as explained in FIGS. 6 and 7. The auxiliary frames 400, 400 is mounted onto the main frame 130 in a manner such that the base portions 428, 444 of each of the auxiliary frames 400, 400′ are placed on the first reinforcement plate 168 and the second reinforcement plate 170, respectively, of the main frame 130. In addition, each of the auxiliary frames 400, 400 is positioned onto the main frame 130 such that its corresponding coupling features 476, 476′ (i.e., third through-holes 478, 478) (and the through-holes 482, 482) are aligned with their respective second mating features 148, 148 (i.e., second through-holes 192, 192′) (and the through-holes 288, 288) of the main frame 130. Next, the fasteners 292, 292′ are inserted into their corresponding third through-holes 478, 478, the through-holes 482, 482, the second through-holes 192, 192, and the through-holes 288, 288, and are tightened to fixedly secure each of the auxiliary frames 400, 400 to the main frame 130.

When the even number of the auxiliary frames 132, such as two auxiliary frames 400, 400′, is mounted on the main frame 130 in the above-discussed configuration, an end of one of the auxiliary frames 132 lies on or along the plane ‘P’ symmetrically bisecting the main frame 130 about the length ‘L1’ of the main frame 130. For instance, as shown in FIG. 9, at least one of the fourth longitudinal end 404 (of the auxiliary frame 400) and the third longitudinal end 402 (of the auxiliary frame 400′) lies on or along the plane ‘P’. As a result of this mounting arrangement for even number of the auxiliary frames 132, a center of gravity defined combinedly by the battery pack 102 and the mounting assembly 128 (i.e., the auxiliary frame 400 and the main frame 130) may be defined on or along the plane ‘P’.

Referring to FIG. 10, coupling of the main frame 130 (along with one auxiliary frame 400 mounted thereon) to the structure 106 of the machine 100 is discussed. Once the auxiliary frame 400 (along with the battery pack 102 mounted thereon) is fixedly coupled to the main frame 130, the main frame 130 may be transported and placed on the structure 106, for example, by using tines of the implement (e.g., forklift) (not shown) received within the corresponding first engagement surfaces 144 (e.g., first engagement surfaces 270, 278) of the main frame 130. The main frame 130 is placed on the structure 106 in a manner that the first connecting features 214, 214 (i.e., the first through-bores 216, 216′), the second connecting features 248, 250 (i.e., the through-bores 252, 254), the third connecting features 284, 284 (i.e., the through-holes 290, 290′), and the fourth connecting features 298 (i.e., the through-holes 300, 302) are aligned with their corresponding mounting arrangements 124. Subsequently, the fasteners 294, 294, 304, 306 are inserted into their corresponding first through-bores 216, 216′, the through-bores 252, 254, the through-holes 290, 290′, and the through-holes 300, 302, and are tightened to fixedly secure the main frame 130 to the structure 106 of the machine 100.

The mounting assembly 128 may be retrofitted (removably) on any machine having a structure, such as the structure 106. The mounting assembly 128 provides a simple and cost-effective solution for mounting battery packs (e.g., the battery pack 102) of varying configurations and types, onto a variety of machines, such as the machine 100. As a result, the mounting assembly 128 may reduce and/or eliminate requirement of different battery mounting structures for mounting different types of battery packs onto different types of machines, thereby reducing overall cost and inventory. In addition, the mounting assembly 128 is provided with provisions (e.g., the first pocket 268, the second pocket 276, the third pocket 464, the fourth pocket 472, the first openings 236, 238, and the second openings 244, 246 that facilitate easy and secure transportation and mounting of the battery packs 102 (mounted thereon).

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the mounting assembly and/or the method of the present disclosure without departing from the scope of the disclosure. Other embodiments will be apparent to those skilled in the art from consideration of the specification and practice of the mounting assembly and/or the method disclosed herein. It is intended that the specification and examples be considered as exemplary only, with a true scope of the disclosure being indicated by the following claims and their equivalent.

What is claimed is:

1. A mounting assembly for mounting one or more battery packs to a machine, the mounting assembly comprising:
a main frame configured to be coupled to a structure of the machine and including first engagement surfaces to engage with an implement to facilitate at least one of a transportation or a mounting of the main frame on the structure, the main frame defining first mating features and second mating features; and
one or more auxiliary frames configured to be coupled to the main frame, each auxiliary frame including:
mounting features to fixedly mount the one or more battery packs on the auxiliary frame;
second engagement surfaces to engage with an equipment to facilitate at least one of a transportation or a mounting of the auxiliary frame on the main frame; and
coupling features configured to be engaged with:
the first mating features when a number of the one or more auxiliary frames to be coupled to the main frame is odd, and
the second mating features when a number of the one or more auxiliary frames to be coupled to the main frame is even.

2. The mounting assembly of claim 1, wherein the main frame is an elongated main frame defining a length, the one or more auxiliary frames are serially mountable onto the elongated main frame along the length such that a center of gravity defined combinedly by the mounting assembly and the one or more battery packs is defined on or along a plane symmetrically bisecting the elongated main frame about the length of the elongated main frame.

3. The mounting assembly of claim 2, wherein the main frame includes a first rail and a second rail spaced from the first rail, each of the first rail and the second rail defines an end plate, wherein the first mating features and the second mating features are defined in the end plate.

4. The mounting assembly of claim 3, wherein the first rail defines a plurality of first channels and the second rail defines a plurality of second channels, wherein the main frame includes:
a first link and a second link received within their corresponding first and second channels coupling the first rail with the second rail, the first link includes a first pocket, the second link including a second pocket, and wherein each of the first pocket and the second pocket includes the first engagement surfaces.

5. The mounting assembly of claim 3, wherein the main frame includes:
a first longitudinal beam coupled to the first rail; and
a second longitudinal beam coupled to the second rail,
wherein each of the first longitudinal beam and the second longitudinal beam includes first connecting features to facilitate coupling the main frame to the structure of the machine.

6. The mounting assembly of claim 5, wherein each of the first rail and the second rail defines a first end and a second end spaced from the first end, wherein the main frame includes:
a first lateral beam extending between the first rail and the second rail coupling the first end of the first rail with the first end of the second rail; and
a second lateral beam extending between the first rail and the second rail coupling the second end of the first rail with the second end of the second rail,
wherein at least one of the first lateral beam and the second lateral beam defines a plurality of openings configured to receive a work tool to facilitate at least one of a transportation or a mounting of the main frame on the structure of the machine.

7. The mounting assembly of claim 6, wherein each of the first lateral beam and the second lateral beam includes second connecting features to facilitate coupling the main frame to the structure of the machine.

8. The mounting assembly of claim 7, wherein the main frame includes:
a plurality of mounting blocks fixedly mounted on the first lateral beam and the second lateral beam, each mounting block of the plurality of mounting blocks is configured to restrict movement of the one or more auxiliary frames and the one or more battery packs with respect to the main frame in a direction along the length of the main frame.

9. The mounting assembly of claim 5, wherein the main frame includes:
a plurality of tiedown rings fixedly mounted on the first longitudinal beam and the second longitudinal beam, each tiedown ring of the plurality of tiedown rings is configured to secure the one or more battery packs to the main frame to facilitate transportation of the one or more battery packs and the mounting assembly.

10. The mounting assembly of claim 2, wherein each auxiliary frame includes a third rail and a fourth rail spaced from the third rail, each of the third rail and the fourth rail defines a base portion and a ridge extending outwardly from the base portion to define a ridge top surface away from the base portion, and wherein the mounting features being defined in the ridge top surface.

11. The mounting assembly of claim 10, wherein the third rail defines a plurality of third channels, the fourth rail defines a plurality of fourth channels, wherein each auxiliary frame includes:
a third link and a fourth link received within their corresponding third and fourth channels coupling the third rail with the fourth rail, and wherein the coupling features being defined in the base portion, the third link, and the fourth link.

12. The mounting assembly of claim 11, wherein the third link includes a third pocket, the fourth link includes a fourth pocket, and wherein each of the third pocket and the fourth pocket includes the second engagement surfaces.

13. The mounting assembly of claim 1, wherein the first mating features include a set of first through-holes, the second mating features include a set of second through-holes, and the coupling features include a set of third through-holes.

14. A method for mounting one or more battery packs to a machine, the method comprising:
coupling a main frame to a structure of the machine, the main frame including first engagement surfaces to engage with an implement to facilitate at least one of a transportation or a mounting of the main frame on the structure, the main frame defining first mating features and second mating features;
coupling one or more auxiliary frames to the main frame, each auxiliary frame including:
mounting features to fixedly mount the one or more battery packs on the auxiliary frame;
second engagement surfaces to engage with an equipment to facilitate at least one of a transportation or a mounting of the auxiliary frame on the main frame; and
coupling features configured to be engaged with:
the first mating features when a number of the one or more auxiliary frames to be coupled to the main frame is odd, and
the second mating features when a number of the one or more auxiliary frames to be coupled to the main frame is even.

15. The method of claim 14, wherein the main frame is an elongated main frame defining a length, wherein coupling the one or more auxiliary frames to the main frame includes:
serially mounting an odd number of the one or more auxiliary frames on the elongated main frame along the length such that a geometrical center of one of the one or more auxiliary frames lies on or along a plane symmetrically bisecting the elongated main frame about the length of the elongated main frame; and
serially mounting an even number of the one or more auxiliary frames on the elongated main frame along the length such that an end of one of the one or more auxiliary frames lies on or along the plane symmetrically bisecting the elongated main frame about the length of the elongated main frame.

16. The method of claim 14, wherein the main frame includes a first rail and a second rail spaced from the first rail, each of the first rail and the second rail defines an end plate, wherein the first mating features and the second mating features are defined in the end plate.

17. The method of claim 16, wherein the first rail defines a plurality of first channels and the second rail defines a plurality of second channels, wherein the main frame includes:
a first link and a second link received within their corresponding first and second channels coupling the first rail with the second rail, the first link includes a first pocket, the second link including a second pocket, and wherein each of the first pocket and the second pocket includes the first engagement surfaces.

18. The method of claim 17, wherein each of the first rail and the second rail defines a first end and a second end spaced from the first end, the main frame includes:
a first longitudinal beam coupled to the first rail and a second longitudinal beam coupled to the second rail;
a first lateral beam extending between the first rail and the second rail coupling the first end of the first rail with the first end of the second rail; and
a second lateral beam extending between the first rail and the second rail coupling the second end of the first rail with the second end of the second rail, wherein:
each of the first longitudinal beam and the second longitudinal beam includes first connecting features to facilitate coupling the main frame to the structure of the machine, and
at least one of the first lateral beam and the second lateral beam defines a plurality of openings configured to receive a work tool to facilitate at least one of a transportation or a mounting of the main frame on the structure of the machine.

19. The method of claim 14, wherein each auxiliary frame includes a third rail and a fourth rail spaced from the third rail, each of the third rail and the fourth rail defines a base portion and a ridge extending outwardly from the base portion to define a ridge top surface away from the base portion, and wherein the mounting features being defined in the ridge top surface.

20. The method of claim 19, wherein the third rail defines a plurality of third channels, the fourth rail defines a plurality of fourth channels, each auxiliary frame includes:
a third link and a fourth link received within their corresponding third and fourth channels coupling the third rail with the fourth rail, the third link includes a third pocket, the fourth link includes a fourth pocket, wherein:
the coupling features being defined in the base, the third link, and the fourth link, and
each of the third pocket and the fourth pocket includes the second engagement surfaces.
